(19) United States
(12) Patent Application Publication
(10) Pub. No.: US 2004/0262581 A1
(43) Pub. Date: Dec. 30, 2004

(54) Electrically conductive compositions and method of manufacture thereof

(76) Inventor: David E. Rodrigues, Southwick, MA (US)

Correspondence Address: CANTOR COLBURN, LLP, 55 GRIFFIN ROAD SOUTH, BLOOMFIELD, CT, 06002

(21) Appl. No.: 10/608,976

(22) Filed: Jun. 27, 2003

(51) Int. Cl. H01B 1/00

(52) U.S. Cl. 252/500

(57) ABSTRACT

A method for manufacturing a composition comprises blending a polymeric resin, carbon nanotubes and a plasticizer at a viscosity effective to maintain the ratio of resistivity in the direction parallel to the flow direction to that in the direction perpendicular to the flow direction to be greater than or equal to about 0.15. A method of manufacturing a composition comprises blending a polyphenylene ether resin with a polyamide resin to form a melt blend; blending a nylon masterbatch comprising carbon nanotubes with the melt blend; blending water into the melt blend; and removing water from the melt blend.

### BACKGOUND

This disclosure relates to electrically conductive compositions and methods of manufacture thereof.

Articles made from polymeric resins are commonly utilized in material-handling and electronic devices such as packaging film, chip carriers, computers, printers and photocopier components where electrostatic dissipation or electromagnetic shielding are important requirements. Electrostatic dissipation (hereinafter ESD) is defined as the transfer of electrostatic charge between bodies at different potentials by direct contact or by an induced electrostatic field. Electromagnetic shielding (hereinafter EM shielding) effectiveness is defined as the ratio (in decibels) of the proportion of an electromagnetic field incident upon the shield that is transmitted through it. As electronic devices become smaller and faster, their sensitivity to electrostatic charges is increased and hence it is generally desirable to utilize polymeric resins that have been modified to provide improved electrostatically dissipative properties. In a similar manner, it is desirable to modify polymeric resins so that they can provide improved electromagnetic shielding while simultaneously retaining some or all of the advantageous mechanical properties of the polymeric resins.

Conductive fillers such as graphite fibers derived from pitch and polyacrylonitrile having diameters larger than 2 micrometers are often incorporated into polymeric resins to improve the electrical properties and achieve ESD and EM shielding. However, because of the large size of these graphite fibers, the incorporation of such fibers generally causes a decrease in the mechanical properties such as impact. In addition, incomplete dispersion of the carbon fibers promotes inhomogeneity within articles derived from the composition. There accordingly remains a need in the art for conductive polymeric compositions, which while providing adequate ESD and EM shielding, can retain their mechanical properties. There also remains a need for methods which can disperse the electrically conductive fillers in such a manner so as to minimize inhomogeneity in article derived from the composition.

### SUMMARY

A method for manufacturing a composition comprises blending a polymeric resin, carbon nanotubes and a plasticizer at a viscosity effective to maintain the ratio of resistivity in the direction parallel to the flow direction to that in the direction perpendicular to the flow direction to be greater than or equal to about 0.15.

A method of manufacturing a composition comprises blending a polyphenylene ether resin with a polyamide resin to form a melt blend; blending a nylon masterbatch comprising carbon nanotubes with the melt blend; blending water into the melt blend; and removing water from the melt blend.

### BRIEF DESCRIPTION OF THE FIGURES

FIG. 1 is a graphical representation of the reduction in melt viscosity as the low melt viscosity polycarbonate (PC 5221) is blended with the high melt viscosity polycarbonate (PC 135);

FIG. 2 is a graphical representation depicting the reduction in bulk electrical resistivity for blends containing 10 and 20 wt %, of the low melt viscosity polycarbonate (PC 5221);

FIG. 3 is a schematic showing how the resistivity parallel to the flow direction (ρₚₐᵣₐₗₗₑₗ) and the resistivity perpendicular to the flow direction (ρ_{perpendicular}) are measured;

FIG. 4 is a graphical representation showing an increase in the ratio of the resistivity parallel to the flow direction to the resistivity perpendicular to the flow direction versus the weight percent of the low melt viscosity polycarbonate (PC 5221);

FIG. 5 is a graphical representation of the reduction in bulk electrical resistivity for a PBT sample having 5 wt % resorcinol diphosphate (RDP);

FIG. 6 is a graphical representation of the melt viscosity for the different Nylon 6,6 samples; and

FIG. 7 is a graphical representation depicting the reduction in bulk electrical resistivity for Nylon 6,6 samples treated with calcium stearate and water.

### DETAILED DESCRIPTION OF PREFERRED EMBODIMENTS

Disclosed herein are methods for manufacturing compositions comprising polymeric resins, carbon nanotubes and an optional plasticizer, such that the composition has a bulk volume resistivity of less than or equal to about 10e⁸ ohm-cm, while displaying impact properties greater than or equal to about 5 kilojoules/square meter and a Class A surface finish. In one embodiment, the method can be utilized to manufacture compositions having a surface resistivity greater than or equal to about 10⁸ ohm/square (ohm/sq) while having a bulk volume resistivity of less than or equal to about 10e⁸ ohm-cm, while displaying impact properties greater than or equal to about 5 kilojoules/square meter and a Class A surface finish. In another embodiment, the method can be used to manufacture compositions having uniform electrical conductivity in mutually perpendicular directions, thus minimizing any inhomogeneity in the electrical conductivity across the bulk of the composition.

Such compositions can be advantageously utilized in computers, electronic goods, semi-conductor components, circuit boards, or the like which need to be protected from electrostatic dissipation. They may also be used advantageously in automotive body panels both for interior and exterior components of automobiles that can be electrostatically painted if desired.

The polymeric resin used in the conductive compositions may be selected from a wide variety of thermoplastic resins, blends of thermoplastic resins, or blends of thermoplastic resins with thermosetting resins. The polymeric resin may also be a blend of polymers, copolymers, terpolymers, or combinations comprising at least one of the foregoing polymeric resins. Specific, but non-limiting examples of thermoplastic resins include polyacetals, polyacrylics, polycarbonates, polystyrenes, polyesters, polyamides, polyamideimides, polyarylates, polyurethanes, polyarylsulfones, polyethersulfones, polyarylene sulfides, polyvinyl chlorides, polysulfones, polyetherimides, polytetrafluoroethylenes, polyetherketones, polyether etherketones, and combinations comprising at least one of the foregoing polymeric resins.

Specific non-limiting examples of blends of thermoplastic resins include acrylonitrile-butadiene-styrene/nylon, polycarbonate/acrylonitrile-butadiene-styrene, polyphenylene ether/polystyrene, polyphenylene ether/polyamide, polycarbonate/polyester, polyphenylene ether/polyolefin, and combinations comprising at least one of the foregoing blends of thermoplastic resins.

The polymeric resin is generally used in amounts of about 5 to about 99.999 weight percent (wt %). Within this range, it is generally desirable use the polymeric resin or resinous blend in an amount of greater than or equal to about 10 wt %, preferably greater or equal to about 30 wt %, and more preferably greater than or equal to about 50 wt % of the total weight of the composition. The polymeric resins or resinous blends are furthermore generally used in amounts less than or equal to about 99.99 wt %, preferably less than or equal to about 99.5 wt %, more preferably less than or equal to about 99.3 wt % of the total weight of the composition.

Carbon nanotubes utilized in the composition may be single wall carbon nanotubes (SWNTs), multiwall carbon nanotubes (MWNTs), vapor grown carbon fibers (VGCF), bucky balls or carbon nanofibers. Single wall carbon nanotubes used in the composition may be produced by laser-evaporation of graphite or carbon arc synthesis. These SWNTs generally have a single wall with outer diameters of about 0.7 to about 2.4 nanometers (nm). SWNTs having aspect ratios of greater than or equal to about 5, preferably greater than or equal to about 100, more preferably greater than or equal to about 1000 are generally utilized in the compositions. While the SWNTs are generally closed structures having hemispherical caps at each end of the respective tubes, it is envisioned that SWNTs having a single open end or both open ends may also be used. The SWNTs generally comprise a central portion, which is hollow, but may be filled with amorphous carbon.

In one embodiment, the SWNTs may exist in the form of rope-like-aggregates. These aggregates are commonly termed “ropes” and are formed as a result of Van der Waal's forces between the individual carbon nanotubes. The individual nanotubes in the ropes may slide against one another and rearrange themselves within the rope in order to minimize the free energy. Ropes generally having between 10 and 10⁵ nanotubes may be used in the compositions. Within this range it is generally desirable to have ropes having greater than or equal to about 100, preferably greater than or equal to about 500 nanotubes. Also desirable are ropes having less than or equal to about 10⁴ nanotubes, preferably less than or equal to about 5,000 nanotubes. It is generally desirable to have ropes in the composition with aspect ratios greater than or equal to about 5, preferably greater than or equal to about 10, preferably greater than or equal to about 100, more preferably greater than or equal to about 1000, and most preferably greater than or equal to about 2000. It is generally desirable for the SWNTs to have an inherent thermal conductivity of at least 2000 W/m-K and an inherent electrical conductivity of 10⁴ Siemens/centimeter (S/cm). It is also generally desirable for the SWNTs to have a tensile strength of at least 80 Gigapascals (GPa) and a stiffness of about 0.5 Tarapascals (TPa).

In another embodiment, the SWNTs may comprise a mixture of metallic nanotubes and semi-conducting nanotubes. Metallic nanotubes are those that display electrical characteristics similar to metals, while the semi-conducting nanotubes are those, which are electrically semi-conducting. In general, the manner in which the graphene sheet is rolled up produces nanotubes of various helical structures. Zigzag and armchair nanotubes constitute the two possible achiral confirmations, all other conformations yield chiral nanotubes. In order to minimize the quantity of SWNTs utilized in the composition, it is generally desirable to have the metallic nanotubes constitute as large a fraction of the total amount of SWNTs used in the composition. It is generally desirable for the SWNTs used in the composition to comprise metallic nanotubes in an amount of greater than or equal to about 1 wt %, preferably greater than or equal to about 20 wt %, more preferably greater than or equal to about 30 wt %, even more preferably greater than or equal to about 50 wt %, and most preferably greater than or equal to about 99.9 wt % of the total weight of the SWNTs. In certain situations it may be is generally desirable for the SWNTs used in the composition to comprise semi-conducting nanotubes in an amount of greater than or equal to about 1 wt %, preferably greater than or equal to about 20 wt %, more preferably greater than or equal to about 30 wt %, even more preferably greater than or equal to about 50 wt %, and most preferably greater than or equal to about 99.9 wt % of the total weight of the SWNTs.

In yet another embodiment, SWNTs used in the composition may comprise impurities. Impurities are generally obtained as a result of the catalysts used in the synthesis of the SWNTs as well from other non-SWNT carbonaceous by-products of the synthesis. Catalytic impurities are generally metals such as cobalt, iron, yttrium, cadmium, copper, nickel, oxides of metals such as ferric oxide, aluminum oxide, silicon dioxide, or the like, or combinations comprising at least one of the foregoing impurities. Carbonaceous by-products of the reaction are generally soot, amorphous carbon, coke, multiwall nanotubes, amorphous nanotubes, amorphous nanofibers or the like, or combinations comprising at least one of the foregoing carbonaceous by-products.

In general, the SWNTs used in the composition may comprise an amount of about 1 to about 80 wt % impurities. Within this range, the SWNTs may have an impurity content greater than or equal to about 5, preferably greater than or equal to about 7, and more preferably greater than or equal to about 8 wt %, of the total weight of the SWNTs. Also desirable within this range, is an impurity content of less than of equal to about 50, preferably less than or equal to about 45, and more preferably less than or equal to about 40 wt % of the total weight of the SWNTs.

The carbon nanotubes utilized in the composition may also be derivatized with functional groups to improve compatibility and facilitate the mixing with the polymeric resin. The SWNTs may be functionalized on either a sidewall, a hemispherical endcap or on both the side wall as well as the hemispherical endcap. Functionalized SWNTs having the formula (I)

[CₙH_{L}]Rₘ (I)

wherein n is an integer, L is a number less than 0.1 n, m is a number less than 0.5 n, and wherein each of R is the same and is selected from SO₃H, COOH, NH₂, OH, R′CHOH, CHO, CN, COCl, COSH, SH, COOR′, SR′, SiR₃′, Si—(OR′)_{y}—R′_{(3-y)}, R″, AlR₂′, halide, ethylenically unsaturated functionalities, epoxide functionalities, or the like, wherein y is an integer equal to or less than 3, R′ is hydrogen, alkyl, aryl, cycloalkyl, or araalkyl, cycloaryl, poly(alkylether), or the like, R″ is fluoroalkyl, fluoroaryl, fluorocycloalkyl, fluoroaralkyl, cycloaryl, X is halide, and Z is carboxylate, trifluoroacetate, or the like, may be used in the compositions. These compositions are uniform in that each of R is the same.

Non-uniformly substituted carbon nanotubes may also be used in the composition. These include compositions of the formula (I) shown above wherein n, L, m, R and the SWNT itself are as defined above, provided that each of R does not contain oxygen, or, if each of R is an oxygen-containing group, COOH is not present.

Also included in the invention are functionalized nanotubes having the formula (II)

[CₙH_{L}][R′—R]ₘ (II)

where n, L, m, R′ and R have the same meaning as above. The carbon atoms, Cₙ, are surface carbons of a carbon nanotube. In both uniformly and non-uniformly substituted carbon nanotubes, the surface atoms Cₙ are reacted. Most carbon atoms in the surface layer of a carbon nanotubeare basal plane carbons. Basal plane carbons are relatively inert to chemical attack. At defect sites, where, for example, the graphitic plane fails to extend fully around the SWNT, there are carbon atoms analogous to the edge carbon atoms of a graphite plane. The edge carbons are reactive and must contain some heteroatom or group to satisfy carbon valency.

The substituted carbon nanotubes described above may advantageously be further functionalized. Such compositions include compositions of the formula (III)

[CₙH_{L}]Aₘ (III)

where the carbons are surface carbons of a carbon nanotube, n, L and m are as described above, A is selected from OY, NHY, —CR′₂—OY, N′Y, C′Y,

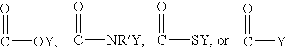

wherein Y is an appropriate functional group of a protein, a peptide, an enzyme, an antibody, a nucleotide, an oligonucleotide, an antigen, or an enzyme substrate, enzyme inhibitor or the transition state analog of an enzyme substrate or is selected from R′OH, R′NH₂, R′SH, R′CHO, R′CN, R′X, R′SiR′₃, RSi—(OR′)_{y}—R′_{(3-y)}, R′Si—(O—SiR′₂)—OR′, R′—R″, R′—N—CO, (C₂H₄ O)_{w}—Y, —(C₃H₆O)_{w}—H, —(C₂H₄O)_{w}—R′, —(C₃H₆O)_{w}—R′ and R′, wherein w is an integer greater than one and less than 200.

The functional carbon nanotubes of structure (II) may also be functionalized to produce compositions having the formula (IV)

[CₙH_{L}][R′—A]ₘ (IV)

where n, L, m, R′ and A are as defined above. The carbon atoms, Cₙ, are surface carbons of the SWNTS.

The compositions of the invention also include carbon nanotubes upon which certain cyclic compounds are adsorbed. These include compositions of matter of the formula (V)

[CₙH_{L}][X—Rₐ]ₘ (V)

where n is an integer, L is a number less than 0.1 n, m is less than 0.5 n, a is zero or a number less than 10, X is a polynuclear aromatic, polyheteronuclear aromatic or metallopolyheteronuclear aromatic moiety and R is as recited above. Preferred cyclic compounds are planar macrocycles as described on p. 76 of Cotton and Wilkinson, Advanced Organic Chemistry. More preferred cyclic compounds for adsorption are porphyrins and phthalocyanines.

The adsorbed cyclic compounds may be functionalized. Such compositions include compounds of the formula (VI)

[CₙH_{L}][X—Aₐ]ₘ (VI)

where m, n, L, a, X and A are as defined above and the carbons are on the carbon nanotube.

Without being bound to a particular theory, the functionalized carbon nanotubes are better dispersed into polymeric resins because the modified surface properties may render the carbon nanotubemore compatible with the polymeric resin, or, because the modified functional groups (particularly hydroxyl or amine groups) are bonded directly to the polymeric resin as terminal groups. In this way, polymeric resins such as polycarbonates, polyamides, polyesters, polyetherimides, or the like, bond directly to the carbon nanotubes making the carbon nanotubes easier to disperse with improved adherence.

Functional groups may generally be introduced onto the outer surface of the carbon nanotubes by contacting the carbon nanotubes with a strong oxidizing agent for a period of time sufficient to oxidize the surface of the carbon nanotubes and further contacting the carbon nanotubes with a reactant suitable for adding a functional group to the oxidized surface. Preferred oxidizing agents are comprised of a solution of an alkali metal chlorate in a strong acid. Preferred alkali metal chlorates are sodium chlorate or potassium chlorate. A preferred strong acid used is sulfuric acid. Periods of time sufficient for oxidation are about 0.5 hours to about 24 hours.

Vapor grown carbon fibers or small graphitic or partially graphitic carbon fibers, also referred to as vapor grown carbon fibers (VGCF), having diameters of about 3.5 to about 2000 nanometers (nm) and an aspect ratio greater than or equal to about 5 may also be used. When VGCF are used, diameters of about 3.5 to about 500 nm are preferred, with diameters of about 3.5 to about 100 nm being more preferred, and diameters of about 3.5 to about 50 nm most preferred. It is also preferable to have average aspect ratios greater than or equal to about 100 and more preferably greater than or equal to about 1000.

carbon nanotubes are generally used in amounts of about 0.0001 to about 50 wt % of the total weight of the composition when desirable. Within this range, carbon nanotubes are generally used in amounts greater than or equal to about 0.25 wt %, preferably greater or equal to about 0.5 wt %, more preferably greater than or equal to about 1 wt % of the total weight of the composition. carbon nanotubes are furthermore generally used in amounts less than or equal to about 30 wt %, preferably less than or equal to about 10 wt %, more preferably less than or equal to about 5 wt % of the total weight of the composition.

Other conductive fillers such as carbon black, conductive metallic fillers, solid non-metallic, conductive fillers, or the like, or combinations comprising at least one of the foregoing may optionally be used in the compositions. Preferred carbon blacks are those having average particle sizes less than about 200 nm, preferably less than about 100 nm, more preferably less than about 50 nm. Preferred conductive carbon blacks may also have surface areas greater than about 200 square meter per gram (m²/g), preferably greater than about 400 m²/g, yet more preferably greater than about 1000 m²/g. Preferred conductive carbon blacks may have a pore volume (dibutyl phthalate absorption) greater than about 40 cubic centimeters per hundred grams (cm³/100 g), preferably greater than about 100 cm³/100 g, more preferably greater than about 150 cm³/100 g. Exemplary carbon blacks include the carbon black commercially available from Columbian Chemicals under the trade name CONDUCTEX®; the acetylene black available from Chevron Chemical, under the trade names S.C.F. (Super Conductive Furnace) and E.C.F. (Electric Conductive Furnace); the carbon blacks available from Cabot Corp. under the trade names VULCAN XC72 and BLACK PEARLS; and the carbon blacks commercially available from Akzo Co. Ltd under the trade names KETJEN BLACK EC 300 and EC 600. Preferred conductive carbon blacks may be used in amounts from about 2 wt % to about 25 wt % based on the total weight of the composition.

Solid conductive metallic fillers may also optionally be used in the conductive compositions. These may be electrically conductive metals or alloys that do not melt under conditions used in incorporating them into the polymeric resin, and fabricating finished articles therefrom. Metals such as aluminum, copper, magnesium, chromium, tin, nickel, silver, iron, titanium, and mixtures comprising any one of the foregoing metals can be incorporated into the polymeric resin as conductive fillers. Physical mixtures and true alloys such as stainless steels, bronzes, and the like, may also serve as conductive filler particles. In addition, a few intermetallic chemical compounds such as borides, carbides, and the like, of these metals, (e.g., titanium diboride) may also serve as conductive filler particles. Solid non-metallic, conductive filler particles such as tin-oxide, indium tin oxide, and the like may also optionally be added to render the polymeric resin conductive. The solid metallic and non-metallic conductive fillers may exist in the form of powder, drawn wires, strands, fibers, tubes, nanotubes, flakes, laminates, platelets, ellipsoids, discs, and other commercially available geometries commonly known in the art.

Non-conductive, non-metallic fillers that have been coated over a substantial portion of their surface with a coherent layer of solid conductive metal may also optionally be used in the conductive compositions. The non-conductive, non-metallic fillers are commonly referred to as substrates, and substrates coated with a layer of solid conductive metal may be referred to as “metal coated fillers”. Typical conductive metals such as aluminum, copper, magnesium, chromium, tin, nickel, silver, iron, titanium, and mixtures comprising any one of the foregoing metals may be used to coat the substrates. Examples of substrates are well known in the art and include those described in “Plastic Additives Handbook, 5^{th} Edition” Hans Zweifel, Ed, Carl Hanser Verlag Publishers, Munich, 2001. Non-limiting examples of such substrates include silica powder, such as fused silica and crystalline silica, boron-nitride powder, boron-silicate powders, alumina, magnesium oxide (or magnesia), wollastonite, including surface-treated wollastonite, calcium sulfate (as its anhydride, dihydrate or trihydrate), calcium carbonate, including chalk, limestone, marble and synthetic, precipitated calcium carbonates, generally in the form of a ground particulates, talc, including fibrous, modular, needle shaped, and lamellar talc, glass spheres, both hollow and solid, kaolin, including hard, soft, calcined kaolin, and kaolin comprising various coatings known in the art to facilitate compatibility with the polymeric matrix resin, mica, feldspar, silicate spheres, flue dust, cenospheres, fillite, aluminosilicate (armospheres), natural silica sand, quartz, quartzite, perlite, tripoli, diatomaceous earth, synthetic silica, and mixtures comprising any one of the foregoing. All of the above substrates may be coated with a layer of metallic material for use in the conductive compositions.

Regardless of the exact size, shape and composition of the solid metallic and non-metallic conductive filler particles, they may be dispersed into the polymeric resin at loadings of about 0.0001 to about 50 wt % of the total weight of the composition when desired. Within this range it is generally desirable to have the solid metallic and non-metallic conductive filler particles in an amount of greater than or equal to about 1 wt %, preferably greater than or equal to about 1.5 wt % and more preferably greater than or equal to about 2 wt % of the total weight of the composition. The loadings of said solid metallic and non-metallic conductive filler particles may be less than or equal to 40 wt %, preferably less than or equal to about 30 wt %, more preferably less than or equal to about 25 wt % of the total weight of the composition.

The plasticizers used in the composition are generally utilized to reduce the viscosity of the composition during the blending of the polymeric resin with the carbon nanotubes. As defined herein, a plasticizer is a low molecular weight organic or inorganic species, which can facilitate a reduction in melt viscosity during the blending of the polymeric resin with the carbon nanotubes. In one embodiment, the plasticizer may actually dissolve the polymeric resin. Suitable examples of such plasticizers are solvents such as alcohols, acetone, toluene, methyl ethyl ketone, liquid carbon dioxide, liquid nitrogen, water, monomers such as styrene, acrylates, or the like. In another embodiment, the plasticizer may only partially solvate the polymeric resin. Suitable examples of such plasticizers are dibutylpthalate, resorcinol diphosphate, vinylidene fluoride, hexafluoropropylene, or the like. In yet another embodiment, the plasticizer may facilitate a suspension of the polymeric resin during the blending process without either partially or completely solvating the polymeric resin.

The blending of the polymeric resin with the carbon nanotubes and the plasticizer may be conducted at any desired temperature. It is generally preferred to conduct the blending at a temperature greater than or equal to about the melting temperature of a semi-crystalline polymeric resin and or the glass transition temperature of an amorphous polymeric resin. In one exemplary embodiment, the plasticizer may be added temporarily to the composition during the blending process. The plasticizer may then be removed from the composition during the blending process or after the blending process. In another embodiment, the plasticizer may be added permanently to the composition.

The polymeric resin together with the plasticizer, the carbon nanotubes and any other optionally desired conductive fillers such as the carbon black, solid metallic and non-metallic conductive filler particles may generally be processed in several different ways such as, but not limited to melt blending, solution blending, or the like, or combinations comprising at least one of the foregoing methods of blending. Melt blending of the composition involves the use of shear force, extensional force, compressive force, ultrasonic energy, electromagnetic energy, thermal energy or combinations comprising at least one of the foregoing forces or forms of energy and is conducted in processing equipment wherein the aforementioned forces are exerted by a single screw, multiple screws, intenneshing co-rotating or counter rotating screws, non-intermeshing co-rotating or counter rotating screws, reciprocating screws, screws with pins, barrels with pins, rolls, rams, helical rotors, or combinations comprising at least one of the foregoing.

Melt blending involving the aforementioned forces may be conducted in machines such as, but not limited to single or multiple screw extruders, Buss kneader, Henschel, helicones, Ross mixer, Banbury, roll mills, molding machines such as injection molding machines, vacuum forming machines, blow molding machine, or then like, or combinations comprising at least one of the foregoing machines. It is generally desirable during melt or solution blending of the composition to impart a specific energy of about 0.01 to about 10 kilowatt-hour/kilogram (kwhr/kg) of the composition. Within this range, a specific energy of greater than or equal to about 0.05, preferably greater than or equal to about 0.08, and more preferably greater than or equal to about 0.09 kwhr/kg is generally desirable for blending the composition. Also desirable is an amount of specific energy less than or equal to about 9, preferably less than or equal to about 8, and more preferably less than or equal to about 7 kwhr/kg for blending the composition.

In one embodiment, the polymeric resin in powder form, pellet form, sheet form, or the like, may be first dry blended with the carbon nanotubes and other optional fillers if desired in a Henschel or a Waring blender, prior to being fed into a melt blending device such as an extruder or Buss kneader. The plasticizer is then added into the melt blending device. In another embodiment, the polymeric resin in powder form, pellet form, sheet form, or the like, may be first blended with the carbon nanotubes and the plasticizer in a Henschel or a Waring Blender, prior to being fed into a melt blending device such as an extruder or Buss kneader. The preferred device for melt blending is a twin screw extruder or a Buss kneader.

As stated above, the use of a plasticizer during blending reduces the viscosity of the blend, which promotes a reduction in shear forces when compared with compositions, which do not utilize the plasticizer. The reduced shear forces promote the preservation of the aspect ratio of the carbon nanotubes. They also promote a reduction in the anisotropy in the electrical properties of the composition. In reducing the anisotropy, it is preferable to have the ratio of resistivity in the direction parallel to the flow direction to that in the direction perpendicular to the flow direction to be greater than or equal to about 0.25, preferably greater than or equal to about 0.4, preferably greater than or equal to about 0.5 and more preferably about equal to 1. The flow direction as defined herein is the direction of flow of the composition during the processing process.

It is moreover preferable to have this ratio greater than or equal to about 0.25 within an area of about 12 square inches, preferably less than or equal to about 10 square inches, more preferably less than or equal to about 5 square inches from a given point on the surface of the composition. Further, it is desirable to have a ratio of greater than or equal to about 0.25 when the composition contains less than or equal to about 3 wt % carbon nanotubes, preferably less than or equal to about 2 wt % carbon nanotubes and less than or equal to about 1 wt % carbon nanotubes, wherein the weight percents are based on the total weight of the composition.

It is generally desirable to reduce the melt viscosity of the composition in an amount of greater than or equal to about 5, preferably greater than or equal to about 15, and more preferably greater than or equal to about 25 percent of the melt viscosity of a composition consisting of the polymeric resin and the carbon nanotubes. It is generally desirable to have the melt viscosity less than or equal to about 60 Pascal-seconds (Pa-s), preferably less than or equal to about 55 Pa-s, preferably less than or equal to about 50 Pa-s, and more preferably less than or equal to about 40 Pa-s, during the melt blending operation.

While it is generally desirable for the shear forces in the melt blending device to generally cause a dispersion of the carbon nanotubes in the polymeric resin, it is also desired to preserve the aspect ratio of the carbon nanotubes during the melt blending process. In order to do so, it may be desirable to introduce the carbon nanotubes into the melt blending device in the form of a masterbatch. In such a process, the masterbatch may be introduced into the melt blending device downstream of the polymeric resin. A melt blend as defined herein is one where at least a portion of the polymeric resin has reached a temperature greater than or equal to about the melting temperature, if the resin is a semi-crystalline polymeric resin, or the flow point (e.g., the glass transition temperature) if the resin is an amorphous resin during the blending process. A dry blend is one where the entire mass of polymeric resin is at a temperature less than or equal to about the melting temperature if the resin is a semi-crystalline polymeric resin, or at a temperature less than or equal to the flow point if the polymeric resin is an amorphous resin and wherein polymeric resin is substantially free of any liquid-like fluid during the blending process. A solution blend, as defined herein, is one where the polymeric resin is suspended in a liquid-like fluid such as, for example, a solvent or a non-solvent during the blending process.

When a masterbatch is used, the carbon nanotubes may be present in the masterbatch in an amount of about 1 to about 50 wt %. Within this range, it is generally desirable to use carbon nanotubes in an amount of greater than or equal to about 1.5 wt %, preferably greater or equal to about 2 wt %, more preferably greater than or equal to about 2.5 wt % of the total weight of the masterbatch. Also desirable are carbon nanotubes in an amount of less than or equal to about 30 wt %, preferably less than or equal to about 10 wt %, more preferably less than or equal to about 5 wt % of the total weight of the masterbatch.

In one embodiment relating to the use of masterbatches in polymeric blends, it is sometimes desirable to have the masterbatch comprising a polymeric resin that is the same as the polymeric resin that forms the continuous phase of the composition. This feature permits the use of substantially smaller proportions of the carbon nanotubes, since only the continuous phase carries the carbon nanotubes that provide the composition with the requisite volume and surface resistivity. In yet another embodiment relating to the use of masterbatches in polymeric blends, it may be desirable to have the masterbatch comprising a polymeric resin that is different in chemistry from other the polymeric resins that are used in the composition. In this case, the polymeric resin of the masterbatch will form the continuous phase in the blend.

The composition comprising the polymeric resin and the carbon nanotubes may be subject to multiple blending and forming steps if desirable. For example, the composition may first be extruded and formed into pellets. The pellets may then be fed into a molding machine where it may be formed into other desirable shapes such as housing for computers, automotive panels that can be electrostatically painted, or the like. Alternatively, the composition emanating from a single melt blender may be formed into sheets or strands and subjected to post-extrusion processes such as annealing, uniaxial or biaxial orientation.

The compositions described above may be used in a wide variety of commercial applications. They may be advantageously utilized as films for packaging electronic components such as computers, electronic goods, semi-conductor components, circuit boards, or the like which need to be protected from electrostatic dissipation. They may also be used internally inside computers and other electronic goods to provide electromagnetic shielding to personnel and other electronics located outside the computer as well as to protect internal computer components from other external electromagnetic interference. They may also be used advantageously in automotive body panels both for interior and exterior components of automobiles that can be electrostatically painted if desired.

The following examples, which are meant to be exemplary, not limiting, illustrate compositions and methods of manufacturing of some of the various embodiments of the electrically conductive compositions described herein.

### EXAMPLES

### Example 1

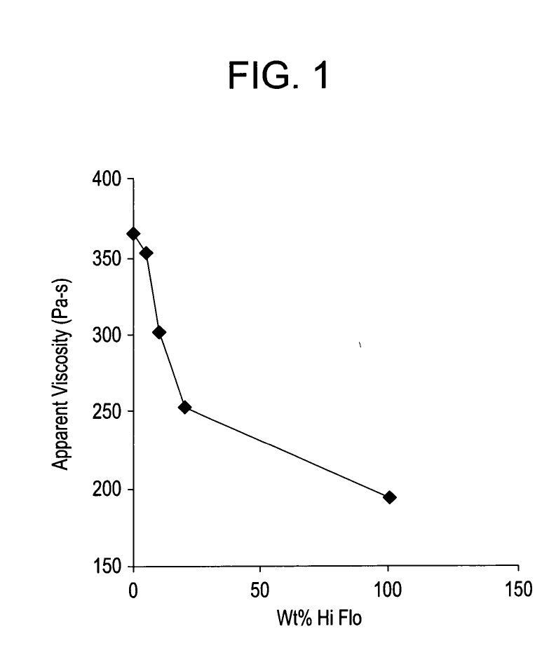

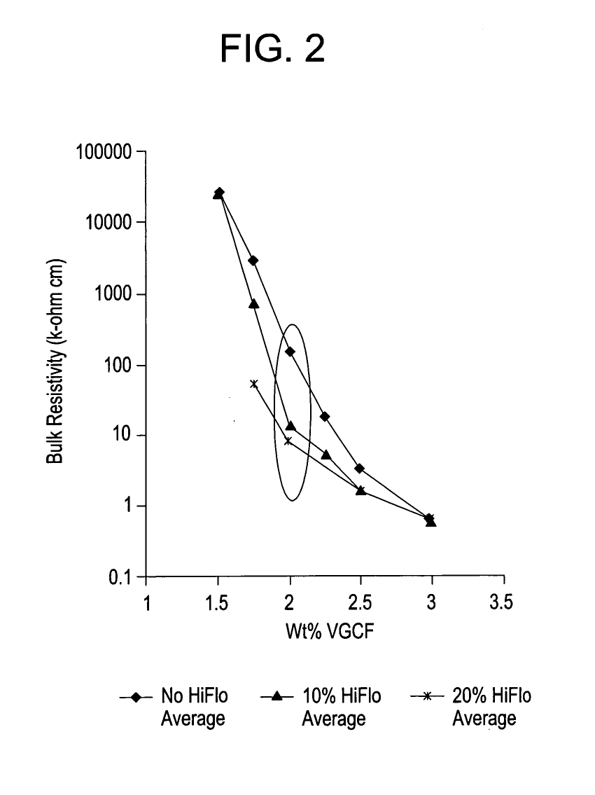

This example was undertaken to demonstrate the effect of the addition of a polymeric resin having a lower melt viscosity to a polymeric resin having a higher melt viscosity. The polymeric resin having the higher melt viscosity at 300° C., was PC135, a polycarbonate resin commercially available from GE Plastics. The resin with the lower melt viscosity was ML5221, a polycarbonate resin also commercially available from GE Plastics. FIG. 1 reflects the reduction in melt viscosity of the blend at 300° C., as larger amounts of ML5221 are added to PC135. The melt viscosity was measured in a Rheometrics rheometer. FIG. 2 reflects the electrical resistivity measurements made on samples of PC135 polycarbonate having 0 wt %, 10 wt % and 20 wt % ML5221 respectively. VGCF obtained from Hyperion Catalysts Inc., were added to the polymeric resin in the form of a masterbatch. The masterbatch contained 15 wt % VGCF. The average fiber diameter of the VGCF was 15.2 nanometers as determined by scanning electron microscopy. The electrical resistivity measurements were made by injection molding dog-bone samples in a 30 ton Engel injection molding machine. The samples were then scored along the neck with a sharp knife at 2 inches distance apart and fractured under liquid nitrogen. The fractured surfaces were dried under ambient conditions and painted over with silver conductive paint. The silver paint was allowed to dry, following which resistivity measurements were made using voltmeter by applying a 1 volt potential to the ends of the sample. The results are shown in FIG. 2. From the figure it may be seen that the as the melt viscosity is reduced by the addition of larger fractions of the lower melt viscosity polycarbonate, the electrical resistivity is reduced. This indicates that the lower melt viscosity of the polymeric resin plays a substantial role in improving electrical conductivity. Thus, lowering the viscosity during the processing, improves the electrical conductivity of the composition.

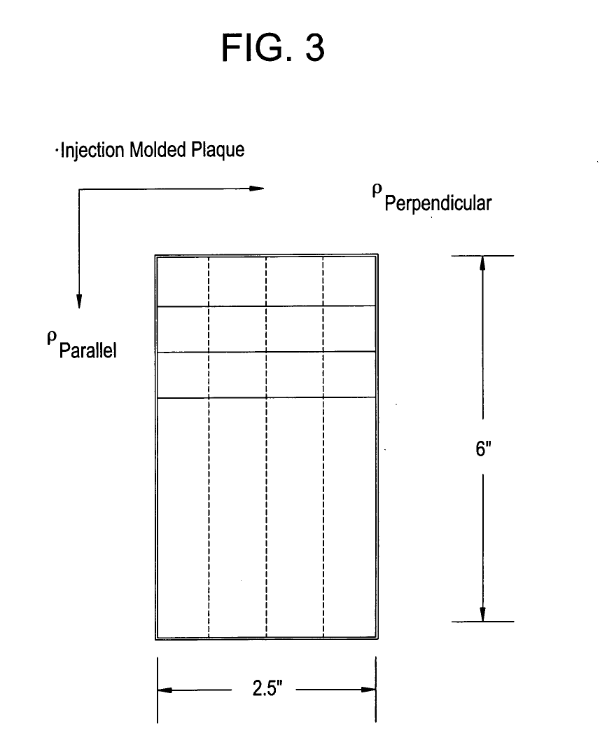

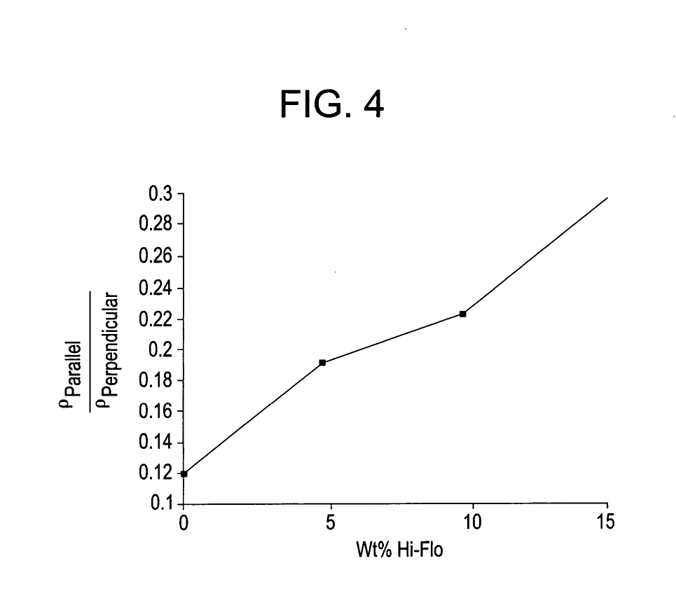

In addition, a study of the anisotropy in the electrical conductivity was made during the processing. The composition contained 2.5 wt % VGCF obtained from Hyperion Catalysts Incorporated. Rectangular plaques of 6″×2.5″ size were injection molded on a 30-ton injection molding machine. The 6″ side was parallel to the flow direction. Five samples were sliced parallel to the flow direction and five samples were sliced perpendicular to the flow direction as shown in FIG. 3. The samples were scored at a distance of 0.5 inches from the ends of the injection molded slices. The samples were fractured and coated with silver paint as described above, following which electrical conductivity measurements were made in the manner described above. The resistivity measurements made parallel to the flow direction were divided by the resistivity measurements made perpendicular to the flow direction and the ratio was plotted against the weight percent of the ML5221 (the low melt viscosity polycarbonate) as seen in FIG. 4. In the figure, Pparallel indicates the resistivity measured parallel to the flow direction while Pperpendicular indicates the resistivity measured perpendicular to the flow direction. A value of 1 would indicates that there is no anisotropy due to the flow in the injection molding machine, while a value of 0 or infinity indicates a large amount of isotropy in the sample. As may be seen in FIG. 4, as the weight percent of the ML5221 is increased from 0 to 15 wt %, the ratio of the resistivity increases from 0.12 to about 0.29, indicating that a melt lower viscosity during blending results in a more uniform distribution of the carbon nanotubes throughout the bulk of the specimen. This results in a lower amount of anisotropy. It may also reflect a better preservation of the aspect ratio of the carbon nanotubes.

### Example 2

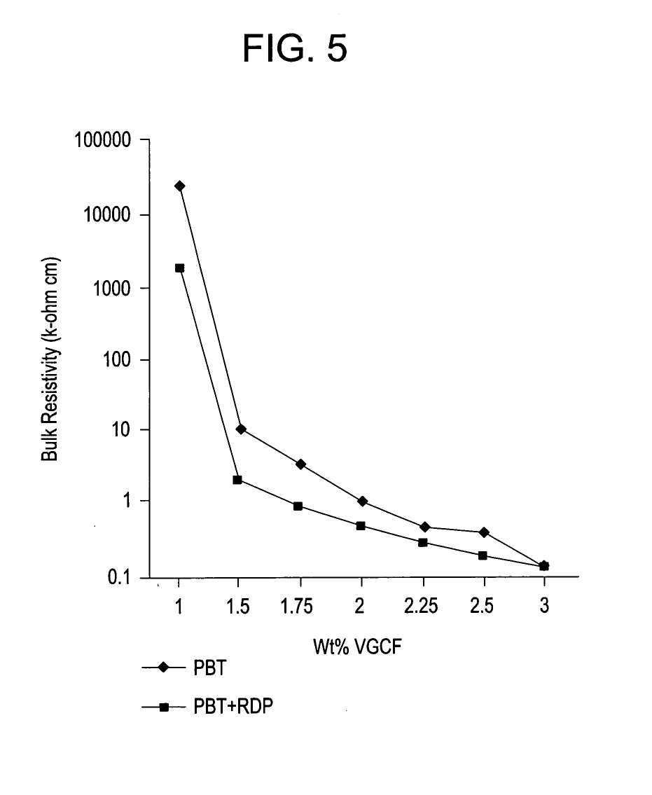

In this experiment, a plasticizer was added in an amount of 5 wt % to the polymeric resin during melt blending. The plasticizer was resorcinol diphosphate (RDP) and the polymeric resin was polybutylene terephthalate (PBT 315) commercially available from GE Plastics. The VGCF were added in masterbatch form at the barrel #7 of the extruder. The PBT-VGCF masterbatch contained 15 wt % VGCF and was commercially available from Hyperion Catalysts Incorporated. The RDP was added to the 30 mm Werner and Pfleiderer twin screw extruder at the barrel #3. The total number of barrels on the twin screw extruder was 10 and the barrel temperature was maintained at about 260° C. The screw speed was 400 rpm. The extrudate was pelletized and injection molded into dog-bone samples as described above. The samples were prepared in the same manner as described above. The electrical resistivity measurements are shown in FIG. 5. From the figure it may be seen that the compositions containing the 5 wt % RDP have a lower resistivity than those compositions having the same weight percent of carbon nanotubes, but no plasticizer.

### Example 3

In this example, Nylon 6,6 having a different melt viscosities were blended with carbon nanotubes in order to ascertain the electrical resistivity. In one of the experiments, water was added to the composition during extrusion. The water was removed during the extrusion process to render a conductive Nylon 6,6 substantially free from water. It may be seen that the temporary addition of water to the composition containing Nylon 6,6 and VGCF reduces the melt viscosity during extrusion, and thus promotes increased electrical conductivity in the material without changing the other physical properties of the composition.

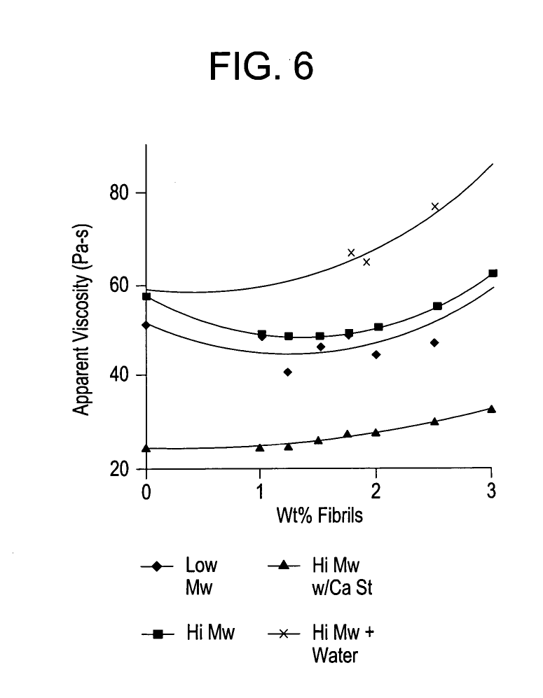

The Nylon 6,6 used for these experiments was obtained from Du Pont. FIG. 6 is a graphical representation of melt viscosity of the Nylon 6,6 containing up to 3 wt % carbon nanotubes. As may be seen in the FIG. 6, the Nylon 6,6 having the high molecular weight has a melt viscosity of 60 Pa-s (pascal-seconds), while the branched Nylon 6,6 has a lower melt viscosity of about 52 Pa-s. Calcium Stearate was added to the high molecular weight Nylon 6,6 to reduce the molecular weight and hence the melt viscosity. The calcium stearate was added in an amount of 0.1 wt %. The melt viscosity of the Nylon 6,6 containing the calcium stearate was 23 Pa-s.

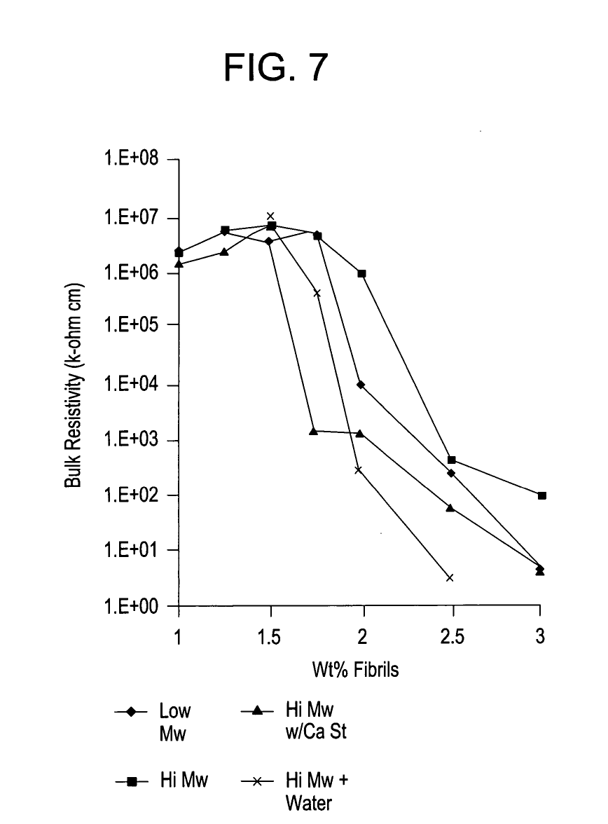

FIG. 7 is a graphical representation showing the bulk resistivity for the samples versus the weight percent carbon nanotubes. From the figure it may be seen that the electrical resistivity is highest for the composition having high molecular weight Nylon 6,6. The composition having the calcium stearate generally has a lower resistivity than the composition having the low molecular weight Nylon 6,6, since as seen from FIG. 6 it has a lower melt viscosity. However, the composition into which water was temporarily introduced has a lower electrical conductivity, despite the fact that it has the same melt viscosity as the high molecular weight Nylon 6,6. Thus by temporarily introducing the water into the composition during melt blending, the electrical resistivity may be reduced, while maintaining other advantageous properties of the composition.

From the above experiments, it may be seen that compositions whose melt viscosity is reduced during blending advantageously have reduced electrical resistivities. This phenomenon may be utilized to reduce the weight fraction of carbon nanotubes in the composition, thereby reducing costs and improving properties of the composition. By reducing the anisotropy of the composition, variations in properties may be reduced. For example, during electrostatic painting, the painted surface appears splotchy when there is anisotropy. By reducing the anisotropy, a smoother paint surface may be achieved.

In reducing the anisotropy, it is preferable to have the ratio of resistivity in the direction parallel to the flow direction to that in the direction perpendicular to the flow direction to be greater than or equal to about 0.15, preferably greater than or equal to about 0.25, preferably greater than or equal to about 0.5 and more preferably about equal to 1. It is moreover preferable to have this ratio greater than or equal to about 0.25 within an area of about 12 square inches, preferably less than or equal to about 10 square inches, more preferably less than or equal to about 5 square inches from a given point on the surface of the composition. Further, it is desirable to have a ratio of greater than or equal to about 0.25 when the composition contains less than or equal to about 3 wt % carbon nanotubes, preferably less than or equal to about 2 wt % carbon nanotubes and less than or equal to about 1 wt % carbon nanotubes, wherein the weight percents are based on the total weight of the composition.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof Therefore, it is intended that the invention not be limited to the particular embodiment disclosed as the best mode contemplated for carrying out this invention, but that the invention will include all embodiments falling within the scope of the appended claims.

What is claimed is:

1. A method for manufacturing a composition comprising:
blending a polymeric resin, carbon nanotubes and a plasticizer at a viscosity effective to maintain the ratio of resistivity in the direction parallel to the flow direction to that in the direction perpendicular to the flow direction to be greater than or equal to about 0.15.

2. The method of claim 1, wherein the polymeric resin is a thermoplastic resin, a thermosetting resin or a blend of a thermoplastic resin with a thermosetting resin.

3. The method of claim 1, wherein the polymeric resin is a polyacetal, a polyacrylic, a polycarbonate, a polystyrene, a polyester, a polyamide, a polyamideimide, a polyarylate, a polyurethane, a polyarylsulfone, a polyethersulfone, a polyarylene sulfide, a polyvinyl chloride, a polysulfone, a polyetherimide, a polytetrafluoroethylene, a polyetherketone, a polyether etherketone, or a combinations comprising at least one of the foregoing polymeric resins.

4. The method of claim 1, wherein the polymeric resin is an acrylonitrile-butadiene-styrene/nylon, polycarbonate/acrylonitrile-butadiene-styrene, polyphenylene ether/polystyrene, polyphenylene ether/polyamide, polycarbonate/polyester, or a polyphenylene ether/polyolefin.

5. The method of claim 1, wherein the carbon nanotubes are single wall carbon nanotubes, multiwall carbon nanotubes, vapor grown carbon fibers, bucky balls or a combination comprising at least one of the foregoing carbon nanotubes.

6. The method of claim 1, wherein the composition further contains electrically conductive filler, wherein the electrically conductive fillers are carbon black, conductive metallic fillers, solid non-metallic, conductive fillers, or combinations comprising at least one of the foregoing electrically conductive fillers.

7. The method of claim 1, wherein the plasticizer can dissolve the polymeric resin.

8. The method of claim 1, wherein the plasticizer can partially dissolve the polymeric resin.

9. The method of claim 1, wherein the blending involves heating the polymeric resin to a temperature greater than its glass transition temperature or to a temperature greater than it melting temperature.

10. The method of claim 1, further comprising injection molding the composition.

11. The method of claim 1, wherein the viscosity effective to maintain the ratio of resistivity in the direction parallel to the flow direction to that in the direction perpendicular to the flow direction to be greater than or equal to about 0.15 is greater than or equal to about 5% less than the viscosity of a composition consisting of the polymeric resin and the carbon nanotubes.

12. The method of claim 1, wherein the viscosity effective to maintain the ratio of resistivity in the direction parallel to the flow direction to that in the direction perpendicular to the flow direction to be greater than or equal to about 0.15 is greater than or equal to about 10% less than the viscosity of a composition consisting of the polymeric resin and the carbon nanotubes.

13. An article derived from the method of claim 1.

14. A method of manufacturing a composition comprising
blending a polyphenylene ether resin with a polyamide resin to form a melt blend;
blending a nylon masterbatch comprising carbon nanotubes with the melt blend;
blending water into the melt blend; and
removing water from the melt blend.

15. The method of claim 14, wherein the carbon nanotubes are single wall carbon nanotubes, multiwall carbon nanotubes, vapor grown carbon fibers, bucky balls or a combination comprising at least one of the foregoing carbon nanotubes.

16. The method of claim 14, wherein the composition has a ratio of resistivity in the direction parallel to the flow direction to that in the direction perpendicular to the flow direction of greater than or equal to about 0.15.

17. The method of claim 14, wherein the composition has a ratio of resistivity in the direction parallel to the flow direction to that in the direction perpendicular to the flow direction of greater than or equal to about 0.25.

18. The method of claim 14, further comprising injection molding the composition.

19. An article derived from the method of claim 14.
